(19) United States
(12) Patent Application Publication
(10) Pub. No.: US 2008/0088749 A1
(43) Pub. Date: Apr. 17, 2008

(54) Television module provided with an antenna on its PC board

(75) Inventor: Robert Wang, Taoyuan (TW)

Correspondence Address: BRUCE H. TROXELL, SUITE 1404, 5205 LEESBURG PIKE, FALLS CHURCH, VA, 22041, US

(73) Assignee: CERAMATE TECHNICAL CO., LTD.

(21) Appl. No.: 11/580,284

(22) Filed: Oct. 13, 2006

(51) Int. Cl. H04N 5/64

(52) U.S. Cl. 348/836

(57) ABSTRACT

A television module provided with an antenna on its PC board includes a PC board, an antenna unit secured on the PC board, a modulation unit fixed on the PC board and connected with the antenna unit, and a digital image processing unit fixed on the PC board, having one end connected with the modulation unit and the other end connected with an image display device. The antenna unit is a printed circuit antenna or a micro-antenna for receiving external wireless signals. The television module and the driving circuit of the image display are assembled together on the same PC board, saving space for assembling the antenna unit and conducive to miniaturization of electronic products.

### BACKGROUND OF THE INVENTION

1. Field of the Invention

This invention relates to a television module, particularly to one provided with an antenna on its PC board for receiving television signals.

2. Description of the Prior Art

Generally, a television signal received and transmitted to the image display 1 of a conventional picture tube television or of a digital liquid crystal television has to be decoded, modulated and then converted into an image signal by a television module 2 that is connected with an antenna 3 for receiving external wireless signals. The conventional antenna 3 is an external antenna, whether it is a stationary outdoor antenna or a stationary indoor antenna or a stationary mobile receiving antenna.

For the present, referring to FIG. 1, a conventional television module, whether it is built in the image display device 1 or it is an independent television reception device, has its antenna 3 positioned independently out of the television module 2, thus forming a comparatively large size and taking much space.

### SUMMARY OF THE INVENTION

The objective of the invention is to offer a television module provided with an antenna on its PC board, and the television module includes a PC board, an antenna unit properly secured on the PC board, a modulation unit properly fixed on the PC board and connected with the antenna unit, and a digital image processing unit disposed on the PC board, having one end connected with the modulation unit and the other end connected with an image display. The antenna unit of this invention is a printed circuit antenna or a micro-antenna secured on the PC board for receiving external wireless signals, needless to take space for assembling the antenna unit and conducive to miniaturization of electronic products.

### BRIEF DESCRIPTION OF DRAWINGS

This invention will be better understood by referring to the accompanying drawings, wherein:

FIG. 1 is a block diagram of a conventional television module;

FIG. 2 is a block diagram of the circuit of a television module in the present invention;

FIG. 3 is a perspective view of a first preferred embodiment of a television module in the present invention; and

FIG. 4 is a perspective view of a second preferred embodiment of a television module in the present invention.

### DETAILED DESCRIPTION OF THE PREFERRED EMBODIMENT

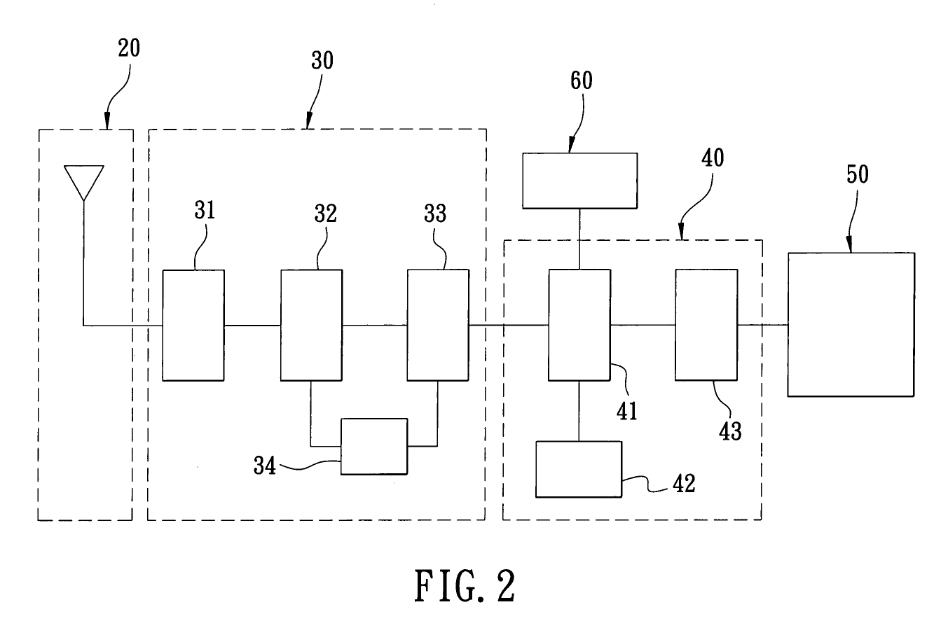

A first preferred embodiment of a television module 4 provided with an antenna on its PC board in the present invention, as shown in FIGS. 2, 3 and 4, includes a PC board 10, an antenna unit 20, a modulation unit 30 and a digital image processing unit 40 as main components combined together.

The PC board 10 is for receiving the IC of the foresaid units thereon.

The antenna unit 20 is a printed circuit antenna 21 formed by printing copper foil on the PC board 10. The printed circuit antenna 21 could be in a bent shape, a labyrinth shape, a Z shape or a whirlpool shape. The antenna unit 20 could also be a micro-antenna 22 secured on the PC board 10. The antenna unit 20 of this preferred embodiment is a bent-shaped printed circuit antenna 21.

The modulation unit 30 properly fixed on the PC board 10 consists of a wave filtering-and-amplifying circuit 31, a tuner 32 and a decoding-modulating device 33. The tuner 32 for modulating different received frequencies has one end connected with the antenna unit 20 by the wave filtering-and-amplifying circuit 31 and the other end connected with the decoding-modulating device 33. The decoding-modulating device 33 could be a specification of DVB-T (Digital Video Broadcasting Television), DVB-H (Digital Video Broadcasting Handhelds), ISDB (Integrated Services Digital Broadcasting) or ATSC (Advanced Television System Committee). The decoding-modulating device 33 of this preferred embodiment is a specification of DVB-T. Both the decoding-modulating device 33 and the tuner 32 are together connected with an automatic gain controller 34.

The digital image-processing unit 40 consists of a multipoint control unit (MCU) 41, a power circuit 42 and an image driving-and-processing circuit 43. The multipoint control unit 41 has one end connected with the modulation unit 30 and the other end connected with an image display 50 by image driving-and-processing circuit 43. The image display 50 of this preferred embodiment is a liquid crystal display. The power circuit 42 is connected with the multipoint control unit 41 for supplying various voltage modes needed by the television module 4. The multipoint control unit 41 could be connected with an external data reading device 60. The external data-reading device 60 of this preferred embodiment is an IC card reader.

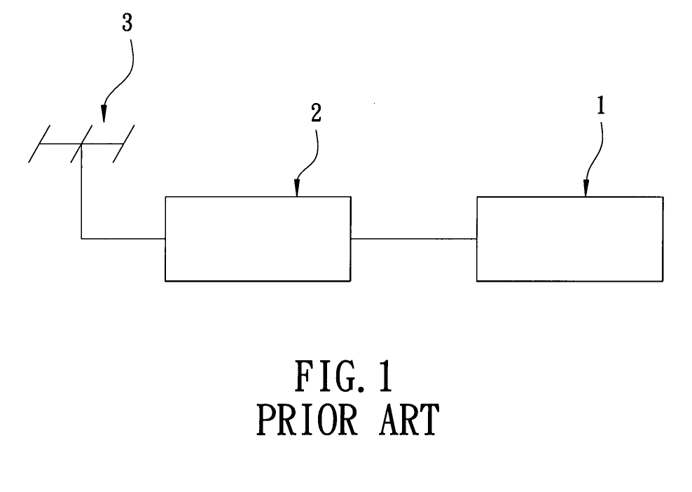

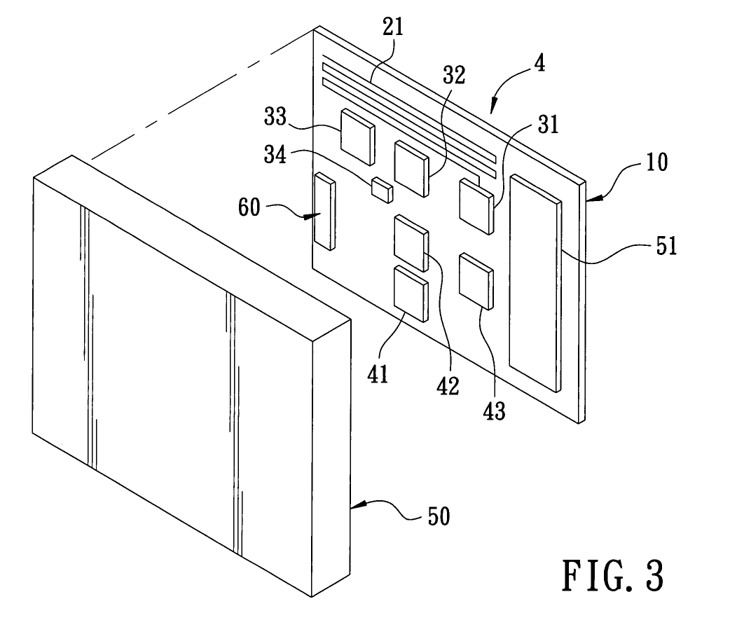

In using, as shown in FIGS. 2 and 3, when an external wireless signal is received by the printed circuit antenna 21, the wireless signal will be transmitted to the wave filtering-and-amplifying circuit 31 of the modulation unit 30, and meanwhile the wave filtering-and-amplifying circuit 31 will filter and amplify the wireless signal received by the printed circuit-antenna 21. Subsequently, the signal is converted into a frequency signal by the tuner 32 and then the frequency signal is transmitted to the decoding-modulating device 33 to be decoded, modulated and then converted into digital image data to be transmitted to the digital image processing unit 40. The automatic gain controller 34 connected between the tuner 32 and the decoding-modulating device 33 functions to carry out feedback control between them. When the multipoint control unit 41 receives the digital image data decoded and modulated by the decoding-modulating device 33 or the digital image data read by the external data reading device 60 and stored in a memorizer, the digital image data will be integrated and transmitted to the image driving-and-processing circuit 43, which connects and controls the driving circuit 51 of the image display 50, letting the digital image data displayed on the image display 50. The television module 4 of this invention can be assembled together with the driving circuit 51 on the same PC board 10 to make up a single module, thus reducing assembling space. The antenna of the conventional television module 2 connected with the image display device 1 is an external antenna, as shown in FIG. 1.

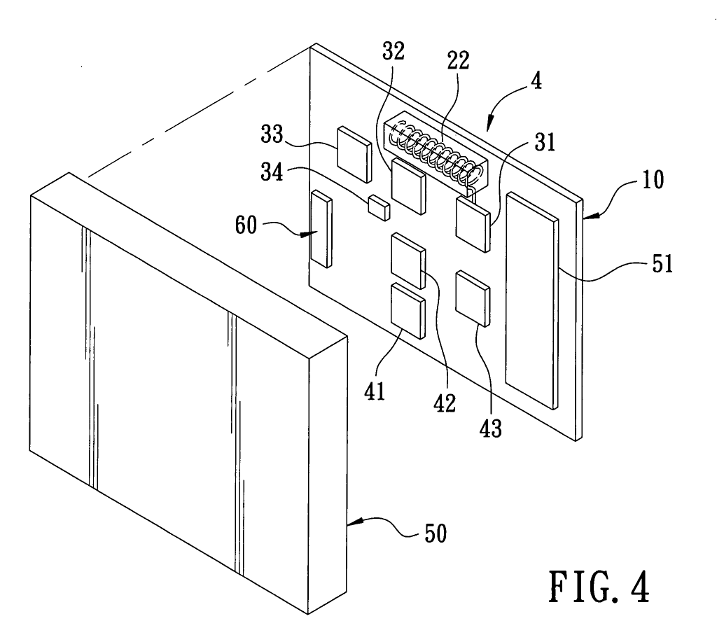

A second preferred embodiment of a television module provided with an antenna on its PC board in the present invention, as shown in FIG. 4, is provided with a micro-antenna 22 for the antenna unit 20 secured on the PC board 10 and having the same function as that described in the first preferred embodiment.

As can be understood from the above description, this invention has the following advantages.

1. The antenna of the television module of this invention is not an external antenna but a printed circuit antenna formed by printing copper foil on the PC board, saving space for assembling the antenna unit.

2. The television module and the driving circuit of the image display can be assembled together on the same PC board to make up a single module, needless to take space for the antenna unit and conducive to miniaturization of electronic products.

While the preferred embodiments of the invention have been described above, it will be recognized and understood that various modifications may be made therein and the appended claims are intended to cover all such modifications that may fall within the spirit and scope of the invention.

I claim:

1. A television module provided with an antenna on its PC board for supplying an image display device with digital image data, said television module comprising:
a PC board;
an antenna unit properly secured on said PC board for receiving external wireless signals;
a modulation unit properly fixed on said PC board, said modulation unit having one end connected with said antenna unit and modulating the external wireless signal received by said antenna unit and converting said wireless signal into a digital image data; and
a digital image processing unit disposed on said PC board, said digital image processing unit having one end connected with said modulation unit, said digital image processing unit integrating said digital image data input from said modulation unit and controlling said image display, which is connected with said digital image processing unit.

2. The television module provided with an antenna on its PC board as claimed in claim 1, wherein said antenna unit is a printed circuit antenna formed by printing copper foil on said PC board.

3. The television module provided with an antenna on its PC board as claimed in claim 2, wherein said printed circuit antenna is bent in shape.

4. The television module provided with an antenna on its PC board as claimed in claim 1, wherein said antenna unit is a micro-antenna.

5. The television module provided with an antenna on its PC board as claimed in claim 1, wherein said modulation unit is composed of a wave filtering-and-amplifying circuit, a tuner and a decoding-modulating device, said tuner having one end connected with said antenna unit by said wave filtering-and-amplifying circuit, said tuner having the other end connected with said decoding-modulating device, which is connected with said digital image processing unit.

6. The television module provided with an antenna on its PC board as claimed in claim 5, wherein said tuner is employed for modulating different received frequencies.

7. The television module provided with an antenna on its PC board as claimed in claim 5, wherein said decoding-modulating device decodes and converts a frequency signal input from said tuner into digital image data.

8. The television module provided with an antenna on its PC board as claimed in claim 5, wherein said decoding-modulating device has a specification of DVB-T (Digital Video Broadcasting Television).

9. The television module provided with an antenna on its PC board as claimed in claim 5, wherein an automatic gain controller is connected with both said decoding-modulating device and said tuner.

10. The television module provided with an antenna on its PC board as claimed in claim 5, wherein said wave filtering-and-amplifying circuit functions to filter and amplify the signal received by said antenna unit.

11. The television module provided with an antenna on its PC board as claimed in claim 1, wherein said digital image processing unit is composed of a multipoint control unit (MCU), a power circuit and an image driving-and-processing circuit, said multipoint control unit connected with said modulation unit for receiving digital image data input from said decoding-modulating device, said multipoint control unit integrating said digital image data and outputting said digital image data to said image display device by said image driving-and-processing circuit.

12. The television module provided with an antenna on its PC board as claimed in claim 1, wherein said television module is built on the driving circuit board of a liquid crystal display.

13. The television module provided with an antenna on its PC board as claimed in claim 1, wherein said digital image processing unit is connected with an external data reading device.

14. The television module provided with an antenna on its PC board as claimed in claim 13, wherein said external data reading device is an IC card reader.
